(19) United States
(12) Patent Application Publication
(10) Pub. No.: US 2010/0205306 A1
(43) Pub. Date: Aug. 12, 2010

(54) GRID COMPUTING SYSTEM, MANAGEMENT APPARATUS, AND METHOD FOR MANAGING A PLURALITY OF NODES

(75) Inventors: Hiroshi Kayanuma, Kawasaki-shi (JP); Kouitirou Takahasi, Kawasaki-shi (JP); Masaki Okuda, Kawasaki-shi (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/702,857

(22) Filed: Feb. 9, 2010

(30) Foreign Application Priority Data
Feb. 10, 2009 (JP) 2009-028930

(51) Int. Cl. G06F 15/16; G06F 9/46; G06F 15/173

(52) U.S. Cl. 709/226; 718/104

(57) ABSTRACT

A grid computing system includes a plurality of nodes for processing a plurality of jobs, and a management apparatus for managing the plurality of the nodes. Each of the nodes is switchable between a standby and an active status, respectively. And the management apparatus including, a job request unit for allotting a plurality of requests of jobs to any of the nodes in an active state, a prediction unit for predicting the number of the nodes in the active state optimal for predicted amount of jobs requested from the exterior at a future time when a predetermined time period lapses from the present time, and a controller for controlling switching of the nodes between the standby and active so as to control the predicted number of the nodes to start switching before the future time.

### CROSS-REFERENCE TO RELATED APPLICATIONS

This application is based upon and claims the benefit of priority of the prior Japanese Patent Application No. 2009-028930, filed on Feb. 10, 2009, the entire contents of which are incorporated herein by reference.

### FIELD

The embodiments discussed herein are related to a grid system, management apparatus, and method for managing plurality of nodes.

### BACKGROUND

There exists a technique called a grid computing that constructs a virtual high-performance computer system by connecting together a plurality of computers via a network. In the grid computing, jobs involving requests for processing are allocated to respective computers to realize distributed processing, thereby increasing its throughput. In the grid computing, a computer to which a job is allocated is called a “calculation node” and a computer for execution of management such as job allocation to each calculation node is called a “management server”.

In the grid computing, even when any job is not allocated to a calculation node, the calculation node is in a “wait for execution state” in which the calculation node is always working and hence the power is wasted accordingly. Thus, there has been proposed a technique for reducing the power consumption by turning a calculation node to which any job is not allocated to a “dormant state” and releasing the dormant state of a calculation node to which a job has been allocated. In this specification, the “dormant state” means that a node turns to a sleep state such as a suspended state or a hibernation state (for example, Japanese Laid-open Patent Publication No. 09-91254).

### SUMMARY

According to an aspect of the embodiments, a grid computing system includes a plurality of nodes for processing a plurality of jobs, and a management apparatus for managing the plurality of the nodes, each of the nodes being switchable between a standby and an active status, respectively. And the management apparatus includes; a job request unit for allotting a plurality of requests of jobs to any of the nodes in an active state, a prediction unit for predicting the number of the nodes in the active state optimal for predicted amount of jobs requested from the exterior at a future time when a predetermined time period lapses from the present time, and a controller for controlling switching of the nodes between the standby and active so as to control the predicted number of the nodes to start switching before the future time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a system configuration diagram illustrating a first embodiment of a grid computing;

FIG. 2 is a diagram illustrating a calculation node state table;

FIG. 3 is a flowchart of a calculation table updating process;

FIG. 4 is a flowchart of a calculation node managing process;

FIG. 5 is a diagram illustrating a calculation node management state under a prerequisite that an increased speed “d”>0, a measure time “b”>a transition time “a” and a surplus value “y”=0;

FIG. 6 is a diagram illustrating a calculation node management state under a prerequisite that the increased speed “d”>0, the measure time “b”<the transition time “a” and the surplus value “y”=0;

FIG. 7 is a system configuration diagram illustrating a second embodiment of a grid computing; and

FIG. 8 is a flowchart of a surplus value setting process.

### DESCRIPTION OF EMBODIMENTS

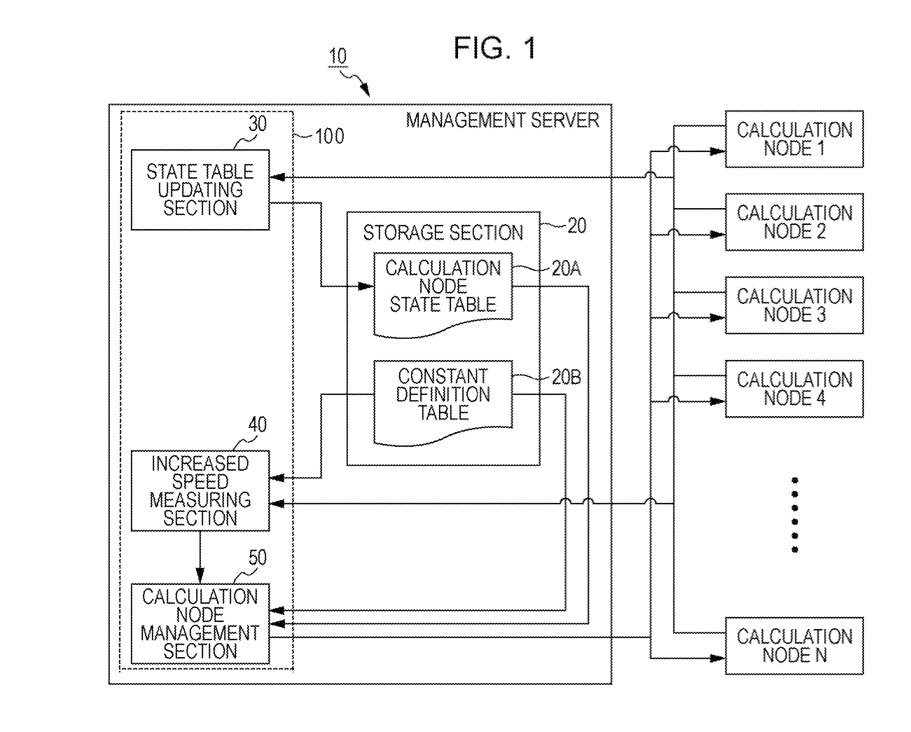

FIG. 1 illustrates a first embodiment of a grid computing.

The grid computing includes a plurality of calculation nodes 1 to N and at least one management server 10 that allocates jobs involving requests for processing to the plurality of calculation nodes 1 to N and makes the nodes execute the jobs.

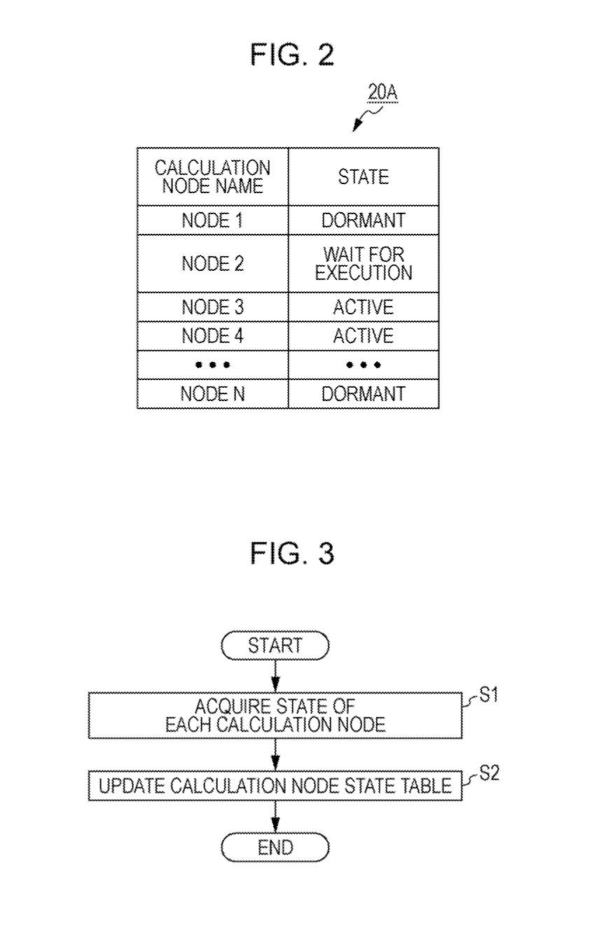

The management server 10 has a storage section 20 constituted by, for example, hard disk drives that respectively store a calculation node state table 20A used to specify the state of each of the calculation nodes 1 to N and a constant definition table 20B that defines various constants indicative of control factors. Incidentally, the storage section 20 is not limited to the hard disk drives and storage devices such as an SSD (Solid State Drive) and an EEPROM (Electrically Erasable Programmable Read Only Memory) may be used as the storage section. As illustrated in FIG. 2, in the calculation node state table 20A, a state of each calculation node, that is, any one of “dormant” indicating that a node concerned is in a dormant state, “wait for execution” indicating that the node is in a wait for execution state and “active” indicating that the node is currently executing a job concerned is set in one-to-one correspondence between the states and the calculation node names. In the constant definition table 20B, a transition time “a” [sec] to transit the calculation nodes 1 to N from the dormant states to the wait for execution states, a measure time “b” [sec] taken to measure a speed “d” [the number of nodes/sec] at which the number of calculation nodes turning to the active states is increased and a surplus value “y” [the number of nodes] are memorized to be rewritable. In the example illustrated in FIG. 2, the surplus value “y” is set to ensure a margin for avoiding shortage of calculation nodes which are in the wait for execution states and is appropriately set by an administrator in accordance with a system operational state.

The processor 100 of management server 10 implements a state table updating section 30, an increased speed measuring section 40 and a calculation node management section 50 respectively by executing a grid computing management program (hereinafter, referred to as a “management program”) installed in a storage device such as a hard disk. In the example illustrated in the drawings, the management program is stored in the storage section 20. The program may be stored in other computer readable recording medium such as a CD-ROM or a DVD-ROM or a nonvolatile memory.

The state table updating section 30 monitors the calculation nodes 1 to N and updates the calculation node state table 20A per predetermined time. The increased speed measuring section 40 monitors the calculation nodes 1 to N over the measure time “b” set in the constant definition table 20B and measures the speed “d” at which the number of calculation nodes which have turned to the active states in the measure time is increased. Incidentally, in the case that the number of calculation nodes which have turned to the active states is decreased, the increased speed “d” of the number of calculation nodes exhibits a negative value. The calculation node management section 50 forecasts an increasing/decreasing trend of jobs to be allocated to the calculation nodes 1 to N by referring to the calculation node state table 20A and the constant definition table 20B and brings the calculation nodes 1 to N into the dormant or wait for execution states in accordance with a result of forecast.

FIG. 3 illustrates a flowchart of a state table updating process that the state table updating section 30 repetitively executes per predetermined time on the basis of execution of the management program.

Next, the updating process illustrated in the flowchart will be described.

First, the state table updating section 30 acquires the states (the dormant, wait for execution or active states) of the respective calculation nodes 1 to N (step 1 (which will be abbreviated as “S1” and so forth in the drawings)).

Next, the state table updating section 30 updates the states set for the respective calculation node names in one-to-one correspondence in the calculation node state table 20A on the basis of the states of the respective calculation nodes 1 to N (step 2).

In the example of the state table updating process illustrated in FIG. 3, the state table updating section 30 updates the calculation node state table 20A per predetermined time. Thus, the latest states of the calculation nodes 1 to N may be recorded in the calculation node state table 20A. Incidentally, the system administrator needs only appropriately set the predetermined time in accordance with the throughput of the management server 10, the transition time “a” and the measure time “b”.

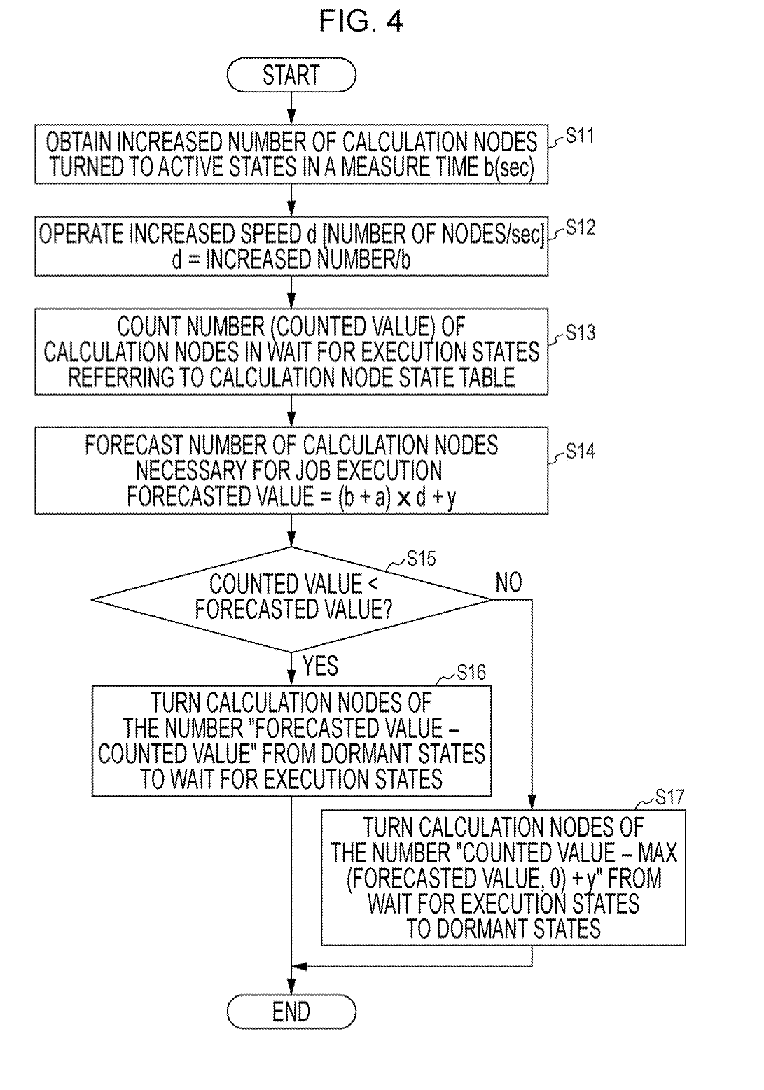

FIG. 4 illustrates a flowchart of a calculation node management process that the increased speed measuring section 40 and the calculation node management section 50 repetitively execute in cooperation with each other on the basis of execution of the management program.

Next, the calculation node management process illustrated in the flowchart will be described.

First, the increased speed measuring section 40 monitors the calculation nodes 1 to N over the measure time “b” [sec] set in the constant definition table 20B and obtains the increased number of calculation nodes [the number of nodes] which have turned to the active states in the measure time (step 11). In the case that the number of calculation nodes which have turned to the active states has been decreased, the increased number exhibits a negative value.

Next, the increased speed measuring section 40 divides the increased number [the number of nodes] by the measure time “b” [sec] to arithmetically operate the increased speed “d” [the number of nodes/sec] indicative of the increased number of calculation nodes which have turned to the active states per unit time (the increased speed “d”=the increased number of nodes/the measure time “b”). Then, the increased speed measuring section 40 outputs the increased speed “d” to the calculation node management section 50 (step 12).

Next, the increased speed measuring section 40 counts the number (a counted value) of calculation nodes whose states recorded in one-to-one correspondence with the calculation node names have been turned to the “wait for execution states” using the calculation node management section 50 with reference to the calculation node state table 20A (step 13).

Next, the calculation node management section 50 forecasts the number of calculation nodes which executes of jobs at a moment that the calculation nodes awake from the dormant states to the wait for execution states (step 14). Specifically, the calculation node management section 50 reads the measure time “b”, the transition time “a” and the surplus value “y” out of the constant definition table 20B and arithmetically operates a forecasted value by substituting the measure time “b”, the transition time “a”, the surplus value “y” and the increased speed “d” into a forecast expression “(b+a)×d+y”.

Next, the calculation node management section 50 judges whether the counted value is less that the forecasted value (step 15). Then, when the counted value is judged to be less than the forecasted value (Yes), the calculation node management section 50 makes the process proceed to step 16. On the other hand, when the counted value is judged to be not less than the forecasted value (No), the calculation node management section 50 makes the process proceed to step 17.

Next, the calculation node management section 50 transits the calculation nodes of the number “the forecasted value−the counted value” from the dormant states to the wait for execution states. Actually, the calculation nodes awake after the transition time “a” has elapsed.

The calculation node management section 50 turns the calculation nodes of the number “the counted value−MAX (the forecasted value, 0)+y” from the wait for execution states to the dormant states. In the example illustrated in FIG. 4, the MAX (the forecasted value, 0) indicates a function used to select one of the counted value and 0 (zero) which is larger than another.

According to the calculation node management process as described above, the increased speed measuring section 40 obtains the increased speed “d” of the number of calculation nodes which have turned to the active states in the measure time “b”. Then, the calculation node management section 50 forecasts the number of calculation node which executes job at a moment that it awakes the calculation nodes from the dormant states to the wait for execution states, considering the increasing/decreasing trend of the jobs which is grasped from the increased speed “d”. In addition, the calculation node management section 50 counts the number of calculation nodes which are in the wait for execution states by referring to the calculation node state table 20A and appropriately changes the states of the calculation nodes to the wait for execution states or the dormant states on the basis of the counted value obtained in the above mentioned manner and the forecasted value.

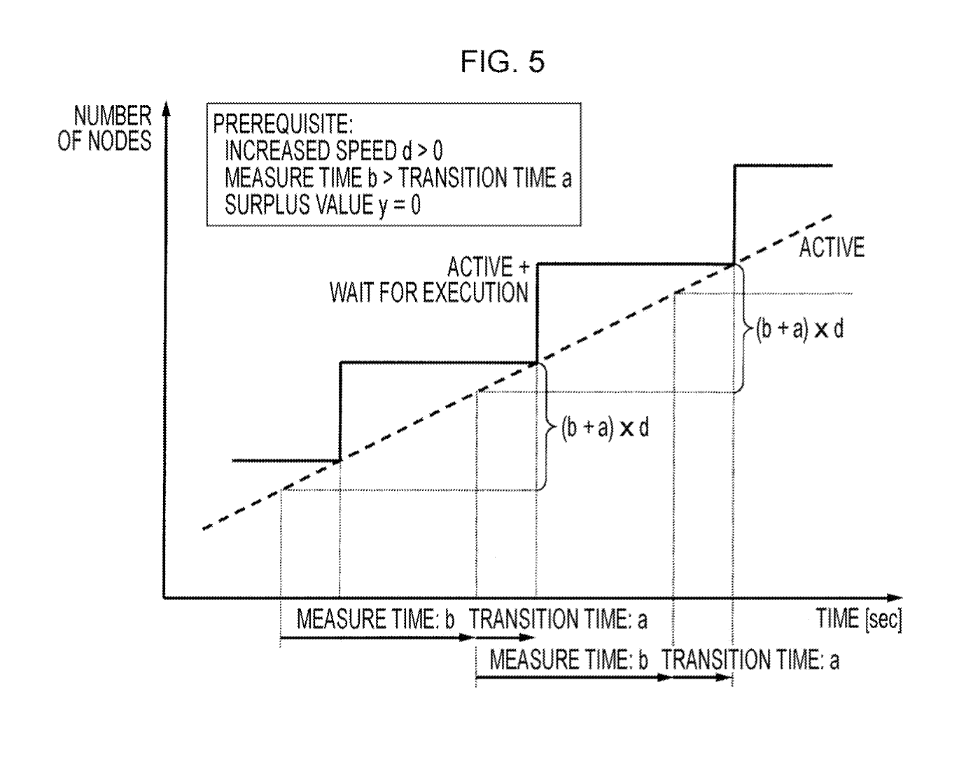

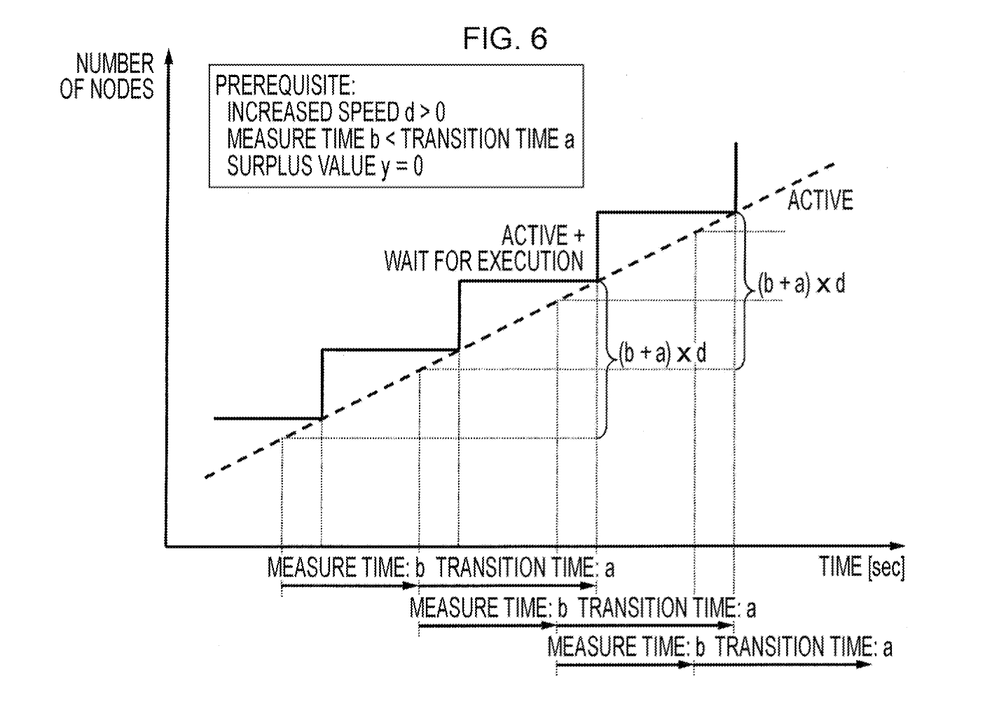

Therefore, in the case that there is observed a trend toward increasing the number of jobs to be allocated to the calculation nodes, the dormant states of the calculation nodes are released in advance as illustrated in FIGS. 5 and 6 so as to increase stepwise the number of calculation nodes which are in the active states or the wait for execution states. On the other hand, in the case that there is observed a trend toward decreasing the number of jobs to be allocated to the calculation node, all the calculation nodes which are in the wait for execution states are changed to the dormant states. Thus, the states of the calculation nodes are changed in accordance with the increasing/decreasing trend of the jobs to be allocated to the calculation nodes in the above mentioned manner, so that the power consumption may be reduced while ensuring the throughput of the grid computing.

Incidentally, it sometimes occurs that in the actual operation of the grid computing, the number of jobs to be executed is suddenly increased temporarily beyond the estimation of the administrator. In the above mentioned case, if the surplus value “y” that the administrator has set is not appropriate, the number of calculation nodes which are in the wait for execution state becomes insufficient. Therefore, the surplus value “y” may be automatically set in accordance with the actual operational state of the grid computing such that shortage of the number of the calculation nodes which are in the wait for execution states hardly occurs as described herein below.

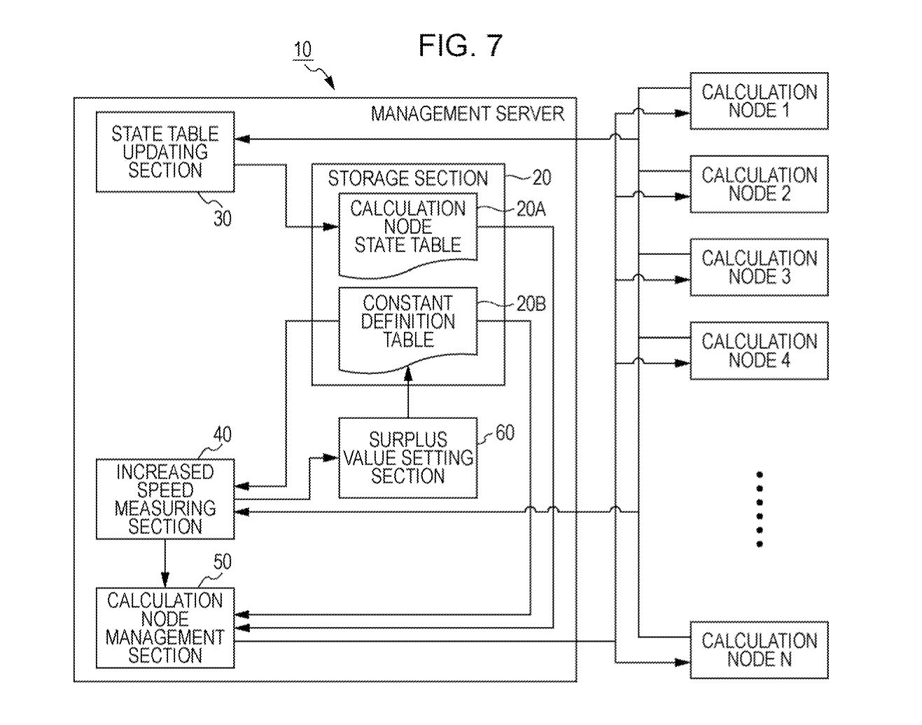

FIG. 7 illustrates a second embodiment of a grid computing configured to automatically set the surplus value “y” in accordance with the actual operational state of the grid computing. Incidentally, most of the constitutional elements in the second embodiment of the grid computing are commonly used in the above mentioned first embodiment. Thus, the same numerals are assigned to the elements common to those in the first embodiment and the description thereof will be omitted or simplified.

The management server 10 includes a surplus value setting section 60 that automatically sets the surplus value “y” stored in the constant definition table 20B on the basis of the increased speed “d” output from the increased speed measuring section 40, in addition to the constitutional elements in the first embodiment illustrated in FIG. 1. Incidentally, the surplus value setting section 60 is implemented by executing the management program using the management server 10.

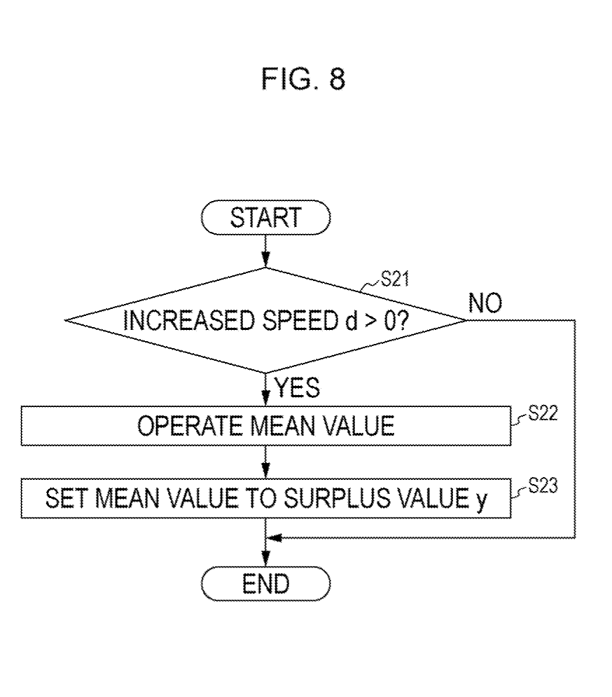

FIG. 8 illustrates a flowchart of a surplus value setting process executed using the surplus value setting section 60 on the basis of acceptance of the increased speed “d” from the increased speed measuring section 40.

Next, the surplus value setting process illustrated in the flowchart in FIG. 8 will be described.

First, the surplus value setting section 60 judges whether the increased speed “d” is positive, that is, the number of jobs to be executed is in an increasing status (step 21). When the increased speed “d” is positive (Yes), the surplus value setting section 60 makes the process proceed to step 22, while when the increased speed is 0 or negative, it terminates the process.

Next, the surplus value setting section 60 arithmetically calculates a mean value of the increased speeds “d” (step 22). In arithmetically calculating the mean value of the increased “d”, for example, the mean value may be obtained from the sequentially stored increased speeds “d” or the mean value may be obtained from an integrated value of the increased speed “d” and the number of integrations thereof.

The surplus value setting section 60 sets (writes) the mean value to (over) the surplus value “y” stored in the constant definition table 20B (step 23).

According to the surplus value setting process as described above, the surplus value setting section 60 automatically sets the surplus value “y” in accordance with the actual operation of the grid computing, so that a margin suited for the actual operation of the grid computing may be ensured and hence shortage of the calculation nodes which are in the wait for execution states may be made hard to occur.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A grid computing system comprising:
a plurality of nodes for processing a plurality of jobs, and a management apparatus for managing the plurality of the nodes;
each of the nodes being switchable between a standby and an active status, respectively; and
the management apparatus including;
a job request unit for allotting a plurality of requests of jobs to any of the nodes in an active state,
a prediction unit for predicting the number of the nodes in the active state optimal for predicted amount of jobs requested from the exterior at a future time when a predetermined time period lapses from the present time, and
a controller for controlling switching of the nodes between the standby and active so as to control the predicted number of the nodes to start switching before the future time.

2. The grid computing system according to claim 1,
wherein the start switching time is the time which the nodes to switch is capable of switching to the active state by time of the future.

3. The grid computing system according to claim 1,
wherein the controller controls the nodes of the predicted number which adds the number predicted by the prediction unit to a predetermined number, when the number predicted by prediction unit is more than a present number of node of active mode.

4. The grid computing system according to claim 1,
wherein the predicted number is the number which adds the number predicted by the prediction unit to a predetermined number.

5. The grid computing system according to claim 1,
wherein the controller controls to switch a part of the nodes to the standby state when the number predicted by prediction unit is less than a present number of node of active mode, the part of the nodes being the active state and being not processing the jobs.

6. A management apparatus for managing a plurality of nodes for processing a plurality of jobs, each of the nodes being switchable between a standby and an active status, respectively, the management apparatus:
a job request unit for allotting a plurality of requests of jobs to any of the nodes in an active state;
a prediction unit for predicting the number of the nodes in the active state optimal for predicted amount of jobs requested from the exterior at a future time when a predetermined time period lapses from the present time; and
a controller for controlling switching of the nodes between the standby and active so as to control the predicted number of the nodes to start switching before the future time.

7. The management apparatus according to claim 6,
wherein the start switching time is the time that the nodes to switch is capable of switching to the active state by time of the future.

8. The management apparatus according to claim 6,
wherein the controller controls the nodes of the predicted number which adds the number predicted by the prediction unit to a predetermined number, when the number predicted by prediction unit is more than a present number of node of active mode.

9. The management apparatus according to claim 6,
wherein the predicted number is the number which adds the number predicted by the prediction unit to a predetermined number.

10. The management apparatus according to claim 6,
wherein the controller controls to switch a part of the nodes to the standby state when the number predicted by prediction unit is less than a present number of node of active mode, the part of the nodes being the active state and being not processing the jobs.

11. A method for managing a plurality of nodes for processing a plurality of jobs, each of the nodes being switchable between a standby and an active status, respectively, the method comprising:
allotting a plurality of requests of jobs to any of the nodes in an active state by a processor.
predicting the number of the nodes in the active state optimal for predicted amount of jobs requested from the exterior at a future time when a predetermined time period lapses from the present time by the processor; and
controlling switching of the nodes between the standby and active so as to control the predicted number of the nodes to start switching before the future time by using a processor.

12. The method according to claim 11,
wherein the start switching time is the time that the nodes to switch is capable of switching to the active state by time of the future.

13. The method according to claim 11,
wherein the predicted number is the number which adds the number predicted by the prediction unit to a predetermined number.

14. A computer-readable recording medium storing a computer program for managing a plurality of nodes, the program being designed to make a computer perform the steps of:
allotting a plurality of requests of jobs to any of the nodes in an active state by a processor;
predicting the number of the nodes in the active state optimal for predicted amount of jobs requested from the exterior at a future time when a predetermined time period lapses from the present time by the processor; and
controlling switching of the nodes between the standby and active so as to control the predicted number of the nodes to start switching before the future time by using a processor.
